(19) United States
(12) Patent Application Publication
(10) Pub. No.: US 2010/0276927 A1
(43) Pub. Date: Nov. 4, 2010

(54) FLOW RESTRICTOR COUPLING

(75) Inventors: Sam Simonian, Paris (FR); Colin Boyle, Elstree (GB); Neale Carter, Hertfordshire (GB)

Correspondence Address: Momkus McCluskey, LLC, 1001 Warrenville Road, Suite 500, Lisle, IL, 60532, US

(73) Assignee: FloTech Holdings Limited, Elstree, Hertfordshire (GB)

(21) Appl. No.: 12/665,524

(22) PCT Filed: Jun. 18, 2008
(86) PCT No.: PCT/GB08/50464

§ 371 Date: Jun. 10, 2010

(51) Int. Cl. F16L 25/00; B23P 11/00

(52) U.S. Cl. 285/383; 29/428

(57) ABSTRACT

The present invention provides a flow restrictor coupling (10) and a method of forming a flow restrictor coupling. The flow restrictor coupling (10) comprises a hollow tubular member (12) having at a first end thereof first means for engagement with an end of a first pipe and, at a second end thereof, second means for engagement with an end of a second pipe, wherein said hollow tubular member (12) is arranged to couple said first pipe to said second pipe and to provide for fluid communication therebetween, said flow restrictor coupling (10) further being arranged to present at least one aperture (26) in a wall of said hollow tubular member between said first and second ends, the aperture (26) having selectively variable dimensions for control of fluid flow therethrough.

The present invention relates to a flow restrictor coupling and particularly to a flow restrictor coupling for an oil well.

When an oil well is drilled it passes directly through an oil reservoir from which oil will be produced to the surface. A bore is drilled into the oil reservoir and a production string is introduced into the bore. Production tubing string is made up of individual tubing sections approximately 9.1 metres (30 feet) long. Attached to the top end of each tubing section is a coupling with two female thread forms to allow corresponding male threads on the end of the tubing sections to be threaded together to create one continuous tubing string.

The rock which makes up the oil reservoir may vary in type and physical characteristics, but the main characteristic of interest is the permeability of the rock. The permeability determines the ease with which the oil can flow through the rock and into the oil well.

Certain rocks such as sandstone have a relatively even permeability and are called homogeneous. Oil can flow through the homogeneous rock at a relatively even pace and will be produced evenly across the drilled section of reservoir. Other reservoir rocks such as limestone and chalk can be heavily, naturally fractured and vary greatly in permeability. These rocks are known as heterogeneous. Oil from a heterogeneous reservoir will produce mainly from the areas of highest permeability where the fractures occur.

Even though the oil well may be drilled through a considerable length of the oil reservoir, the high permeability zones may account for only 10-15% of the length of the drilled reservoir section. If allowed to produce directly into the drilled hole and production tubing string, the oil will never be produced from the remaining 85-90% of the drilled section thus reducing the efficiency of the oil well.

A second problem is that directly beneath the oil reservoir there is typically a layer of naturally occurring water. When a well is drilled the aim is to produce as much oil as possible and to limit the amount of natural water produced. Over time as the oil is depleted, it is replaced by the natural water seeping up from the rock below it. In a homogeneous reservoir the water may rise slowly and evenly, prolonging the time before water eventually breaks through into the well bore. In a heterogeneous reservoir the mixed permeability of the reservoir and the natural faulting may allow water to be produced almost immediately at the expense of oil production.

To overcome these two problems of producing oil from a heterogeneous oil reservoir a number of mechanical components have been designed to control the flow of oil into the production tubing string. Historically the oil was allowed to flow from the hole drilled through the reservoir directly into the production tubing string via the open end of the tubing string or via holes drilled evenly along the length of the tubing string. This method of production made no difference to the permeability of the reservoir and resulted in production from a limited portion of the drilled section leading to early water break-through.

It was discovered that if the flow of oil from the reservoir could be mechanically restricted as it passed into the tubing string, the resulting back pressure created would allow sections of the reservoir with lower permeabilities that would not normally get a chance to produce, due to the higher permeability zones, to contribute to the well's production. This effectively increased the oil producing area of the reservoir and extended the time before eventual water break-through.

Devices which invoke this effect come in a variety of forms and have the common feature of restricting flow by creating a pressure drop as the oil passes through them. The restriction can take the form of a series of orifices or a tortuous flow path. The devices are provided in the production tubing string and are spaced out at intervals across the reservoir section. As the oil produces it will pass out of the oil reservoir rock and fill the annular area between the bore hole drilled through the reservoir and the outside of the production tubing string. It will then flow towards the flow restriction devices and enter the production tubing string as described above.

Due to the expense of these flow restriction devices a limited number are placed in the well. For example, a production tubing string passing through a 1000 metre section of reservoir may only be provided with between 5 and 10 devices. This limits the efficiency of the process and may reduce the extent of oil producing zones and thus reduce the time until water breakthrough.

The present invention seeks to provide for a flow restrictor coupling having advantages over known such couplings.

In this regard, the present invention relates to a device capable of creating the necessary flow restriction and resultant pressure drop that can be produced at a fraction of the price of current devices. This allows an oilfield operator to install larger quantities of the device more evenly distributed across the oil reservoir. The result of this will be a more efficient production from a greater proportion of the reservoir and an extension of the time until water break-through.

In a production tubing string incorporating the present invention, the standard couplings of a production tubing string are replaced with flow restrictor couplings according to the invention.

According to an aspect of the present invention, there is provided a flow restrictor coupling comprising: a hollow tubular member having at a first end thereof first means for engagement with an end of a first pipe and, at a second end thereof, second means for engagement with an end of a second pipe, wherein said hollow tubular member is arranged to couple said first pipe to said second pipe and to provide for fluid communication therebetween, said flow restrictor coupling further being arranged to present at least one aperture in a wall of said hollow tubular member between said first and second ends, the aperture having selectively variable dimensions for control of fluid flow therethrough.

An advantage of the present invention is that, as oil is produced, it must pass through the at least one aperture to gain access to the production tubing string to be produced at the surface. By altering the number of apertures in the flow restrictor coupling and the diameter of the at least one aperture, each coupling can be set up to create a specific pressure drop for a given flow rate. This choking effect creates a back pressure on higher quality sections of the reservoir allowing tighter sections to contribute, thereby evening out the inflow profile from the well. This evening out of the inflow profile will result in better coning control, therefore prolonging the lifetime of the well before water break-through.

Since the flow restrictor couplings according to the present invention are less expensive to produce than existing devices on the market an oilfield operator has the ability to install a far greater number of them across the reservoir section resulting in the advantages listed above.

Preferably, fluid flow through said aperture is fixed upon selection of the aperture dimensions.

Conveniently, said at least one aperture is arranged to receive an insert member arranged to control the said fluid flow.

Further, said at least one insert member is formed with an aperture to allow fluid flow therethrough and such that, when said insert member is located in said at least one corresponding aperture of said hollow tubular member, said aperture of said insert member provides fluid communication between an exterior of said hollow tubular member and an interior of said hollow tubular member.

Also, said at least one aperture of said hollow tubular member is provided with a thread for engagebly receiving said insert member which is similarly provided with an external thread.

In particular, the rate of fluid flow between the exterior of said hollow tubular member and the interior of said hollow tubular member via said aperture of said insert member is variable dependent on the number of insert members present in said hollow tubular member.

Additionally, the rate of fluid flow between the exterior of said hollow tubular member and the interior of said hollow tubular member via said aperture of said insert member is further variable by replacing at least one of a plurality of insert members with a corresponding blank insert member arranged for engagement with said corresponding at least one aperture of said hollow tubular member and further arranged to prevent fluid flowing between the exterior of said hollow tubular member and the interior of said hollow tubular member via the corresponding at least one aperture of said hollow tubular member in which said blank insert member is located.

Preferably, the coupling further comprises centralising means arranged to space regions of said flow restrictor coupling from formations external to said flow restrictor coupling.

Conveniently, said centralising means comprises an annular member provided with an internal thread for engagement with an external thread provided on the exterior of said hollow tubular member.

If required, said centralising means is formed as part of said hollow tubular member such that the wall of said hollow tubular member is thicker in the region of the centralising means than the portion of the hollow tubular member where said insert member is located.

Further, said centralising means is located either at one end, or both ends, of said hollow tubular member.

Also, said first and second means of engagement comprise female threads arranged to cooperate with corresponding male threads at ends of said first and second pipes respectively.

In particular, a portion of the interior surface at a mid region of said hollow tubular member and remote from the innermost ends of said female threads is unthreaded.

Additionally, said at least one aperture of said hollow tubular member extends through a wall of said hollow tubular member at a position corresponding to said mid region.

Alternatively, said first and second means of engagement comprise male threads arranged to cooperate with corresponding female threads at ends of said first and second pipes respectively.

According to another aspect of the present invention, there is provided an insert member for use as the insert member described above.

According to a further aspect of the present invention, there is provided a blank insert member for use as the blank insert member described above.

According to yet another aspect of the present invention, there is provided a centralising means for use as the centralising means described above.

According to another aspect of the present invention, there is provided a pipeline system comprising a plurality of pipe sections and a plurality of flow restrictor couplings as described above, wherein said each flow restrictor coupling serves to couple adjacent pipe sections to allow fluid communication between said adjacent pipe sections.

According to another aspect of the present invention, there is provided a method of forming a flow restrictor coupling, comprising the steps of: providing a hollow tubular member having at a first end thereof first means for engagement with an end of a first pipe and, at a second end thereof, second means for engagement with an end of a second pipe; forming at least one aperture in a wall of said hollow tubular member between said first and second ends.

Preferably, the method further comprises the step of: locating, in said at least one aperture, a flow-restricting insert member.

Conveniently, the method further comprises the step of: forming said at least one aperture with a thread for engagebly receiving said corresponding at least one insert member which is similarly formed with a thread.

Further, said insert member presents a flow-restricting aperture.

In particular, the method further comprises the step of providing said coupling with a centralising means arranged to space regions of said flow restrictor coupling from formations external to said flow restrictor coupling.

According to another aspect of the present invention, there is provided a flow restrictor coupling formed according to the above method.

The present invention is described further hereinafter, by way of example only, with reference to the accompanying drawings in which:

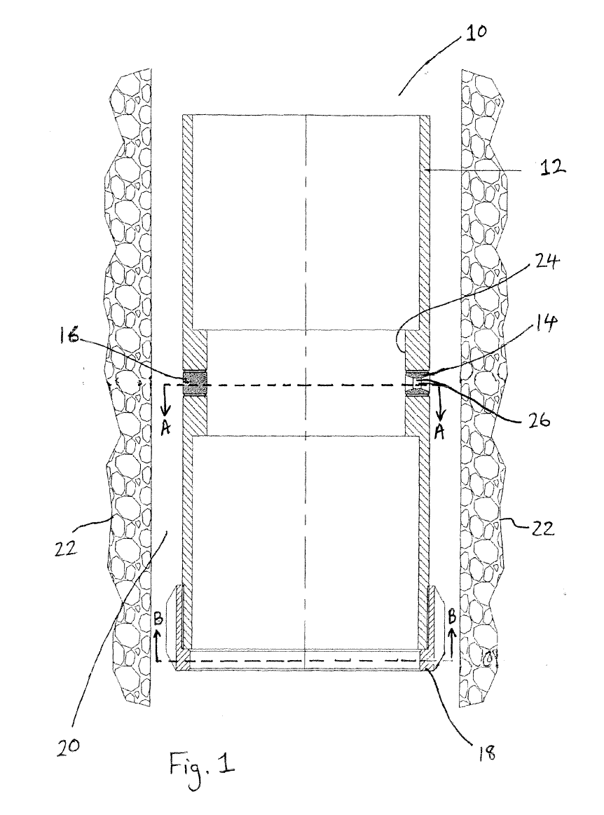

FIG. 1 illustrates a cross-sectional, side view of a flow restrictor coupling in-situ;

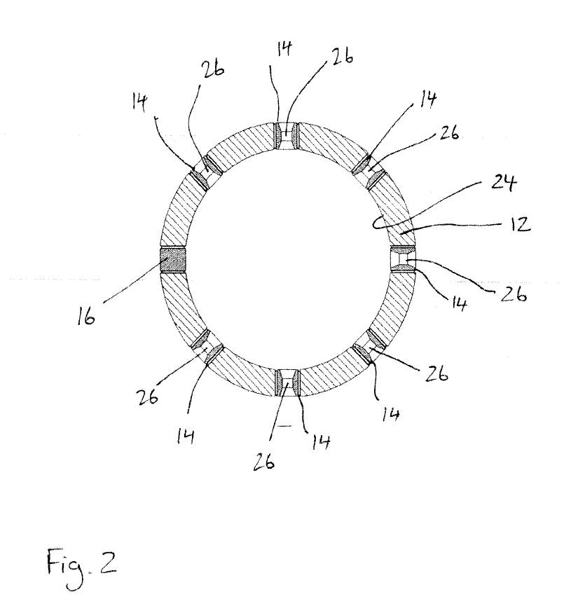

FIG. 2 illustrates a cross-sectional top view of the flow restrictor coupling of FIG. 1 taken along the line A-A;

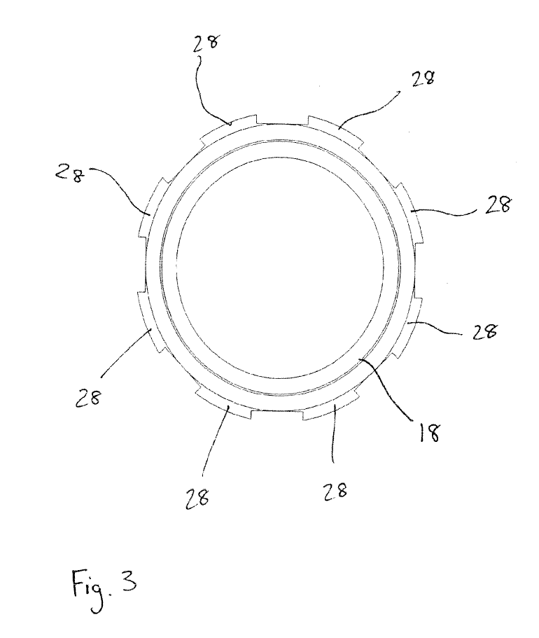

FIG. 3 illustrates a cross-sectional bottom view of the flow restrictor coupling of FIG. 1 taken along the line B-B; and

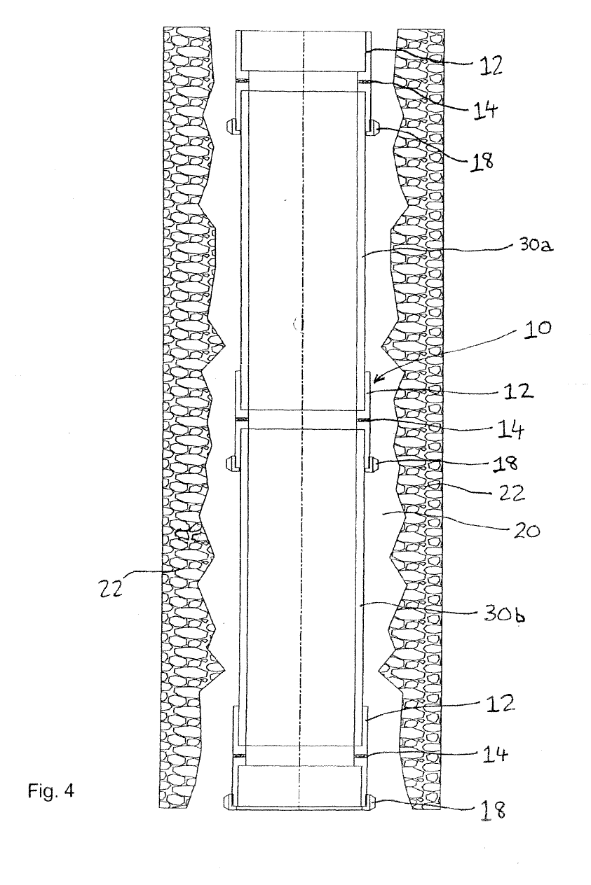

FIG. 4 illustrates a cross-sectional side view of a production tubing string in-situ and comprising a plurality of flow restrictor couplings according to the present invention.

As mentioned, FIG. 1 illustrates a flow restrictor coupling 10, which comprises four main components, namely: a coupling body 12; a nozzle 14; a blank nozzle 16; and a centraliser 18. The flow restrictor coupling 10 is illustrated in-situ, i.e. in an oil-well bore hole 20 drilled in an oil-bearing rock 22. Tubing sections of a production tubing string are not illustrated in FIG. 1 in order to aid clarity.

Coupling body 12 comprises a hollow tubular member (preferably a thin-walled steel cylinder) having means at each end thereof for engaging with a tubing section so as to couple together adjacent tubing sections. The engaging means preferably comprise female thread forms machined in the interior wall of the hollow tubular member at each end thereof. These female threads are arranged to mate with corresponding male thread forms at the ends of tubing sections. Thus, since the thread form on coupling body 12 matches the mating thread form on the production tubing sections, the production tubing sections can be coupled together to form a production tubing string.

In the above preferred form of the present invention, the female thread forms do not extend along the entire length of the interior wall of the coupling body 12, but rather extend only part way from the ends of the coupling body 12 along its length toward the centre. Thus, in this arrangement, a section 24 of the interior wall of the coupling body remains unthreaded between the innermost ends of the female thread forms.

At least one aperture is formed/provided in the wall of the coupling body 12 and extends between an exterior surface of the coupling body 12 to an interior surface of the coupling body 12 to allow fluid communication between the exterior and interior of the coupling body 12. The at least one aperture is formed/provided preferably at the mid-point along the length of the coupling body 12: a position which corresponds to section 24. Preferably, a plurality of apertures are formed/provided in the wall of the coupling body 12 and are equally spaced around the perimeter of the coupling body 12.

In one arrangement, the apertures can themselves form the means by which fluid flows from the exterior of the coupling body 12 to a flow passage of the production tubing string in the interior of the coupling body 12. However, in a preferable embodiment, the apertures are each arranged to receive a corresponding nozzle 14 or blank nozzle 16.

The nozzles 14/blank nozzles 16 may engage with the apertures formed in the coupling body 12 by any suitable means but preferably, the apertures are provided with a thread, with such a thread arranged to mate with a corresponding thread provided on the exterior of the nozzle 14 or blank nozzle 16. Thus, the nozzle 14 or blank nozzle 16 can be threaded directly into the apertures of the coupling body 12.

Each nozzle 14 has an internal orifice 26 of given diameter to create a specific pressure drop for a specific flow rate of oil and water. By altering the number of nozzles 14 installed in each flow restrictor coupling 10 and/or the size of the orifice 26 selected, an operator can pre-set the desired pressure drop for a given flow rate.

In order to resist erosion from the produced fluid over time, the nozzles 14/blank nozzles 16 are preferably manufactured from a very hard, wear-resistant, material such as tungsten carbide.

Blank nozzles 16 have substantially the same external dimensions as nozzles 14 so that they can be threaded into the apertures in coupling body 12. However, blank nozzles 16 differ from nozzles 14 in that they do not have an orifice and so do not allow fluid to pass between the exterior of the flow restrictor coupling 10 and the flow passage of the production tubing string in the interior of the flow restrictor coupling 10. Thus, the blank nozzles 16 can be used to replace nozzles 14 if the flow area through the combined nozzles 14/blank nozzles 16 is to be limited further.

Centraliser 18 is located around the periphery of coupling body 12 and serves to hold the coupling body 12 and nozzles 14 away from the faces of the oil-well bore hole 20 in the oil reservoir. Typically, an oil-well bore hole is drilled horizontally or at a very shallow angle with the result that a production tubing string within the bore hole will lie against one side of the bore hole. Thus, without the centraliser 18, the coupling body 12 might lie directly against the oil-well bore hole face and the entrance to the nozzle(s) would be partially or fully blocked, thereby affecting the desired pressure restriction characteristics of the present invention.

In the illustrated embodiment, centraliser 18 is a ring-shaped member provided with an internal thread (not shown) which is arranged to engage with a corresponding thread around the external periphery of the coupling body 12.

However, in other arrangements, the centraliser 18 need not be a discrete element, and may form part of the exterior of the coupling body 12. For example, the centraliser 18 may comprise a section of said coupling body 12 which protrudes from the external surface of the coupling body 12. Such a section may be located at a centre, an end, or both ends of the coupling body, or at any point between the ends. Furthermore, the section need not be a continuous protrusion around the perimeter of the coupling body 12, but may comprise a number of protrusions separate from one another and located around the perimeter of the coupling body 12.

Flow restrictor couplings 10 are provided in the production tubing string across an oil reservoir zone. Produced oil can only enter the production tubing string through the nozzles 14 mounted in the flow restrictor couplings 10. The nozzles 14 restrict the flow of oil into the production tubing string creating a pressure drop for any given flow rate which can be varied by altering the number of nozzles 14 and the diameter of the orifice in each nozzle 14. The pressure drop created allows oil to be produced from areas of the reservoir which would otherwise remain unproductive as the oil would take the path of least resistance and flow only from the most permeable regions.

The features illustrated in FIGS. 2 and 3 which correspond to features already described in the above embodiment are denoted by like reference numerals and will not be discussed further.

As stated above, FIG. 2 illustrates a cross-sectional top view of the flow restrictor coupling 10 of FIG. 1 taken along the line A-A. In the illustrated arrangement, the coupling body 12 is provided with eight equally spaced apertures about its periphery, with seven of the apertures each containing therein a nozzle 14, and with the eighth aperture containing a blank nozzle 16.

Also, in the arrangement of FIG. 2, the apertures of the coupling body 12 for receiving the nozzles 14/blank nozzles 16 are located at positions around the periphery of the coupling body 12 such that pairs of said apertures are diametrically opposite.

FIG. 3 illustrates the ring-shaped member forming the centraliser 18. In this embodiment, the centraliser 18 includes protrusions 28 equally spaced about a periphery of the centraliser 18. It is these protrusions 28 which space regions of the flow restrictor coupling 10 from rock (or other matter) surrounding the flow restrictor coupling 10 when the flow restrictor coupling 10 is located in a bore-hole.

As stated above, FIG. 4 illustrates a cross-sectional side view of a production tubing string in-situ and comprising a plurality of flow restrictor couplings according to the present invention.

The features illustrated in FIG. 4 which correspond to features already described above are denoted by like reference numerals and will not be discussed further.

In the illustrated arrangement, two pipe sections 30a, 30b of a production tubing string located in a bore-hole 20 are coupled together by means of a flow restrictor coupling 10 according to the present invention. These pipe sections 30a, 3b are also provided with further flow restrictor couplings 10 at ends remote from the section where they are coupled together. These further flow restrictor couplings 10 are arranged to couple the pipe sections 30a, 30b to pipe sections (not shown) adjacent the remote ends in order to form the production tubing string.

1. A flow restrictor coupling comprising:
a hollow tubular member having at a first end thereof first means for engagement with an end of a first pipe and, at a second end thereof, second means for engagement with an end of a second pipe, wherein said hollow tubular member is arranged to couple said first pipe to said second pipe and to provide for fluid communication therebetween, said flow restrictor coupling further being arranged to present at least one aperture in a wall of said hollow tubular member between said first and second ends, the aperture having selectively variable dimensions for control of fluid flow therethrough.

2. A coupling according to claim 1, wherein fluid flow through said aperture is fixed upon selection of the aperture dimensions.

3. A coupling according to claim 1, wherein said at least one aperture is arranged to receive an insert member arranged to control said fluid flow.

4. A coupling according to claim 3, wherein said insert member is formed with an aperture to allow fluid flow therethrough and such that, when said insert member is located in said at least one corresponding aperture of said hollow tubular member, said aperture of said insert member provides fluid communication between an exterior of said hollow tubular member and an interior of said hollow tubular member.

5. A coupling according to claim 3, wherein said at least one aperture of said hollow tubular member is provided with a thread for engagebly receiving said insert member which is similarly provided with an external thread.

6. A coupling according to claim 3, wherein the rate of fluid flow between the exterior of said hollow tubular member and the interior of said hollow tubular member via said aperture of said insert member is variable dependent on the number of insert members present in said hollow tubular member.

7. A coupling according to claim 3, wherein the rate of fluid flow between the exterior of said hollow tubular member and the interior of said hollow tubular member via said aperture of said insert member is further variable by replacing at least one of a plurality of insert members with a corresponding blank insert member arranged for engagement with said corresponding at least one aperture of said hollow tubular member and further arranged to prevent fluid flowing between the exterior of said hollow tubular member and the interior of said hollow tubular member via the corresponding at least one aperture of said hollow tubular member in which said blank insert member is located.

8. A coupling according to claim 1, further comprising centralising means arranged to space regions of said flow restrictor coupling from formations external to said flow restrictor coupling.

9. A coupling according to claim 8, wherein said centralising means (18) comprises an annular member provided with an internal thread for engagement with an external thread provided on the exterior of said hollow tubular member.

10. A coupling according to claim 8, wherein said centralising means is formed as part of said hollow tubular member such that the wall of said hollow tubular member is thicker in the region of the centralising means than the portion of the hollow tubular member where said insert member is located.

11. A coupling according to claim 8, wherein said centralising means is located either at one end, or both ends, of said hollow tubular member.

12. A coupling according to claim 1, wherein said first and second means of engagement comprise female threads arranged to cooperate with corresponding male threads at ends of said first and second pipes respectively.

13. A coupling according to claim 12, wherein a portion of the interior surface at a mid region of said hollow tubular member and remote from the innermost ends of said female threads is unthreaded.

14. A coupling according to claim 13, wherein said at least one aperture of said hollow tubular member extends through a wall of said hollow tubular member at a position corresponding to said mid region.

15. A coupling according to claim 1, wherein said first and second means of engagement comprise male threads arranged to cooperate with corresponding female threads at ends of said first and second pipes respectively.

16. (canceled)

17. (canceled)

18. (canceled)

19. (canceled)

20. A method of forming a flow restrictor coupling, comprising the steps of:
providing a hollow tubular member having at a first end thereof first means for engagement with an end of a first pipe and, at a second end thereof, second means for engagement with an end of a second pipe; and
forming at least one aperture in a wall of said hollow tubular member between said first and second ends.

21. A method according to claim 20, further comprising the step of: locating, in said at least one aperture, a flow-restricting insert member.

22. A method according to claim 21, further comprising forming said at least one aperture with a thread for engageably receiving said insert member which is similarly formed with a thread.

23. A method according to claim 22, wherein said insert member presents a flow-restricting aperture.

24. A method according to claim 20, further comprising the step of providing said coupling with a centralising means arranged to space regions of said flow restrictor coupling from formations external to said flow restrictor coupling.

25. (canceled)
